(19) United States
(12) Patent Application Publication
(10) Pub. No.: US 2026/0142600 A1
(43) Pub. Date: May 21, 2026

(54) Method, Apparatus, and Device for Generating a Motor Drive Signal, and Readable Storage Medium

(71) Applicant: AAC Acoustic Technologies (Shanghai) Co., Ltd., Shanghai (CN)

(72) Inventors: Mengya Cao, Shanghai (CN); Shiyu Pei, Shanghai (CN); Yajun Zheng, Shanghai (CN); Shuhan Yao, Shanghai (CN)

(21) Appl. No.: 19/322,654

(22) Filed: Sep. 8, 2025

Related U.S. Application Data
(63) Continuation of application No. PCT/CN2024/133593, filed on Nov. 21, 2024.

(51) Int. Cl. H02P 23/00; G06F 3/01; H02P 25/032

(52) U.S. Cl. CPC H02P 23/0077; G06F 3/016; H02P 23/0022; H02P 25/032; H02P 2209/11

(57) ABSTRACT

Disclosed are a method, an apparatus, and a device for generating a motor drive signal, and a readable storage medium. The method includes: plotting an initial waveform curve based on vibration waveform information of a motor and generating a first waveform signal corresponding to the initial waveform curve; resampling the first waveform signal based on a preset sampling rate and a duration of the first waveform signal to obtain a second waveform signal; and performing filtering processing and displacement protection processing to the second waveform signal to obtain a motor drive signal, where the motor drive signal is configured to drive the motor to vibrate within a target operating frequency band. The disclosure enables designing of a motor vibration tactility effect through signal waveform plotting, which offers efficient waveform plotting and signal generation and enhances motor tactile experience of user.

### FIELD

The present disclosure relates to electronics, and more particularly relates to a method, an apparatus, and a device for generating a motor drive signal, and a readable storage medium.

### BACKGROUND

With technological advancements of consumer electronics, their user experience has been increasingly emphasized. For example, in order not to disturb others, vibration feedback is developed to alert a user of an incoming call, a text message, a gaming event, or like notifications. The vibration feedback is produced by a motor actuated by an electronic signal (i.e., a drive signal). A waveform graph is used to describe current or voltage change of the drive signal over time; and different shapes of waveforms correspond to different operating modes and characteristics of the motor.

In conventional technologies, motor vibration is generally controlled by waveform superimposition. However, for a signal difficult to be split in advance, it likely occurs that split computation in drive signal generation would be time-consuming and inefficient, and in some cases, an eligible drive signal cannot be generated from the split computation.

### SUMMARY

A method, an apparatus, and a device for generating a motor drive signal, and a readable storage medium are described herein, which at least can solve a problem in the conventional technologies that an actual vibration tactility of a motor needs improvement.

In a first aspect of the implementations of the disclosure, there is provided a method of generating a motor drive signal, comprising steps of:
plotting an initial waveform curve based on vibration waveform information of a motor and generating a first waveform signal corresponding to the initial waveform curve, wherein the vibration waveform information is vibration information allowing for a vibration action of the motor to satisfy a requirement of desired tactility, and the waveform curve characterizes change of signal amplitude over time;
resampling the first waveform signal based on a preset sampling rate and a duration of the first waveform signal to obtain a second waveform signal; and
performing filtering processing and displacement protection processing to the second waveform signal to obtain a motor drive signal, wherein the motor drive signal is configured to drive the motor to vibrate within a target operating frequency band.

In a second aspect of the disclosure, there is provided an apparatus for generating a motor drive signal, comprising:
a waveform plotting module configured to plot an initial waveform curve based on vibration waveform information of a motor and generate a first waveform signal corresponding to the initial waveform curve, wherein the vibration waveform information is vibration information allowing for a vibration action of the motor to satisfy a requirement of desired tactility, and the waveform curve characterizes change of signal amplitude over time;
a resampling module configured to resample the first waveform signal based on a preset sampling rate and a duration of the first waveform signal to obtain a second waveform signal; and
a signal optimizing module configured to perform filtering processing and displacement protection processing to the second waveform signal to obtain the motor drive signal, wherein the motor drive signal is configured to drive the motor to vibrate within a target operating frequency band.

In a third aspect of the implementations of the disclosure, there is provided an electronic device, comprising: a memory and a processor, wherein: the processor is configured to execute a computer program stored on the memory; and the processor, when executing the computer program, performs steps in the method of generating a motor drive signal provided in the first aspect of the implementations of the disclosure.

In a fourth aspect of the implementations of the disclosure, there is provided a computer-readable storage medium having a computer program stored thereon, wherein the computer program, when being executed by the processor, performs steps in the method of generating a motor drive signal provided in the first aspect of the implementations of the disclosure.

In view of the above, the method, the apparatus, and the device for generating a motor drive signal, and a readable storage medium described herein are applied to: plot an initial waveform curve based on vibration waveform information of a motor and generate a first waveform signal corresponding to the initial waveform curve, wherein the vibration waveform information is vibration information allowing for a vibration action of the motor to satisfy a requirement of desired tactility, and the waveform curve characterizes change of signal amplitude over time; resample the first waveform signal based on a preset sampling rate and a duration of the first waveform signal to obtain a second waveform signal; and perform filtering processing and displacement protection processing to the second waveform signal to obtain the motor drive signal, wherein the motor drive signal is configured to drive the motor to vibrate within a target operating frequency band. Through implementation of the present solution, a desired motor drive signal can be generated by plotting a waveform dependent on different tactile requirements of users or application scenarios, and optimizing the waveform signal by resampling, filtering processing, and displacement protection processing, which minimizes a difference between the actual vibration tactility of the motor and the ideal vibration tactility, whereby tactile experience of users is enhanced.

### BRIEF DESCRIPTION OF THE DRAWINGS

FIG. 1 is a basic flow diagram of a method of generating a motor drive signal according to a first implementation of the disclosure;

FIG. 2 is a schematic diagram of key data points of an initial waveform curve in a first planar coordinate system according to the first implementation of the disclosure;

FIG. 3 is a schematic diagram of an initial waveform curve with continuous data points according to the first implementation of the disclosure;

FIG. 4 is a schematic diagram of mapping the initial waveform curve into a reference waveform curve in a second planar coordinate system according to the first implementation of the disclosure;

FIG. 5 is a process schematic diagram of thinning treatment of the reference waveform curve of a second waveform signal according to the first implementation of the disclosure;

FIG. 6 is an operating flow diagram of a displacement protection module according to the first implementation of the disclosure;

FIG. 7 is an operating flow diagram of generating and applying a motor drive signal according to the first implementation of the disclosure;

FIG. 8 is a detailed flow diagram of a method of generating a motor drive signal according to a second implementation of the disclosure;

FIG. 9 is a program module diagram of an apparatus for generating a motor drive signal according to a third implementation of the disclosure;

FIG. 10 is a structural schematic diagram of an electronic device according to a fourth implementation of the disclosure.

### DETAILED DESCRIPTION OF EMBODIMENTS

To make the objectives, features, and advantages of the disclosure more apparent and comprehensible, the technical solutions in the implementations of the disclosure will be described in a clear and comprehensive manner with reference to the accompanying drawings; it is apparent that the example implementations described herein are only part of the implementations of the disclosure, not all of them. All other implementations obtained by those skilled in the art based on the implementations described herein without exercise of inventive work would fall within the scope of protection of the disclosure.

In the description of the disclosure, it needs to be understood that the orientational or positional relationships indicated by the terms “length,” “width,” “center,” “upper,” “lower,” “front,” “rear,” “left,” “right,” “vertical,” “horizontal,” “top,” “bottom,” “inner,” “outer,” and etc. are orientational and positional relationships based on the drawings, which are intended only for facilitating description of the disclosure and simplifying relevant illustrations, not for indicating or implying that the devices or elements compulsorily possess those specific orientations and are compulsorily configured and operated with those specific orientations; therefore, such terms should not be construed as limitations to the disclosure.

Besides, the terms “first” and “second” are only used for descriptive purposes, which shall not be construed as indicating or implying relative importance or implicitly indicating the quantity of a referred to technical feature. Therefore, the features limited by “first” and “second” may explicitly or implicitly include one or more of such features. In the implementations described herein, “plurality” indicates two or above, unless otherwise indicated.

In the disclosure, unless otherwise explicitly provided and limited, the terms such as “mount,” “connect,” “attach,” and “fix” should be understood broadly, which, for example, may refer to a fixed connection, a detachable connection, or an integral connection; which may be a mechanical connection or an electrical connection; which may be a direct connection or an indirect connection via an intermediate medium; which may also be a communication between the insides of two elements or an interaction between two elements. To a person of normal skill in the art, specific meanings of the above terms in the disclosure may be construed dependent on specific situations.

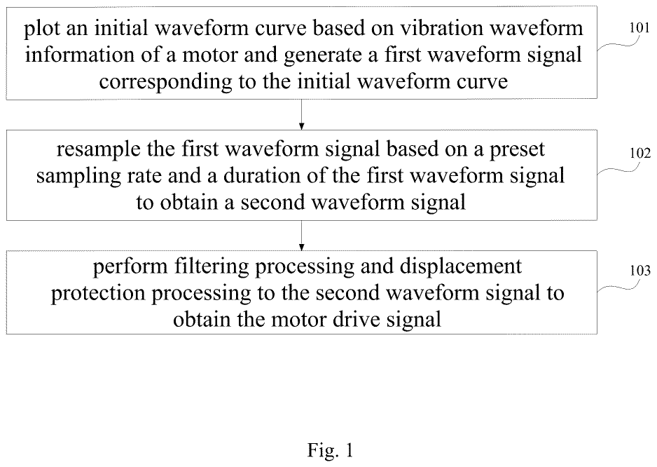

To overcome the technical problem that actual vibration tactility of a motor in conventional technologies needs improvement, a first implementation of the disclosure provides a method of generating a motor drive signal, a basic flow diagram of which is illustrated in FIG. 1; the method of generating a motor drive signal comprises:

Step 101: plot an initial waveform curve based on vibration waveform information of a motor and generate a first waveform signal corresponding to the initial waveform curve.

Specifically, in this implementation, the vibration waveform information is waveform information allows for a vibration action of the motor to meet a requirement of desired tactility, and the waveform curve characterizes change of signal amplitude over time. In some examples, the waveform signal may be pre-plotted using a plotting strategy such as electronic manual plotting or image recognition, i.e., a tactility effect of the motor vibration may be designed according to user demands. It may be understood that, the initial waveform curve may be plotted using a system default plotting strategy or based on an operation command of a specified plotting strategy inputted by a user, which is not limited herein.

In some examples of this implementation, the step of plotting an initial waveform curve based on vibration waveform information of a motor and generating a first waveform signal corresponding to the initial waveform curve comprises: determining, based on the vibration waveform information of the motor, first coordinate parameters of respective key data points of the first waveform signal in a first planar coordinate system; and plotting the initial waveform curve based on the respective first coordinate parameters and generating the first waveform signal corresponding to the initial waveform curve.

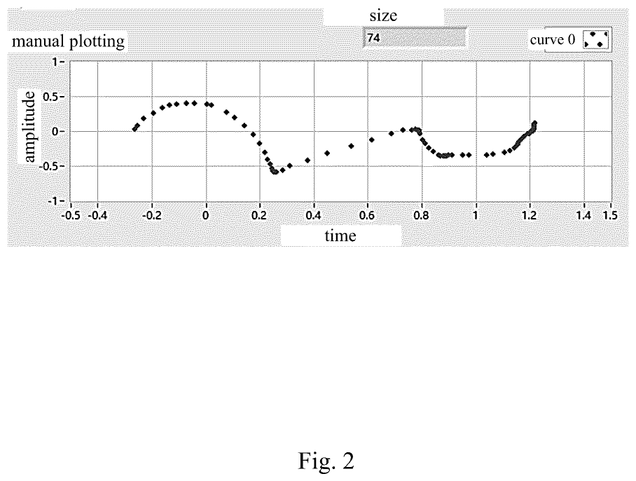

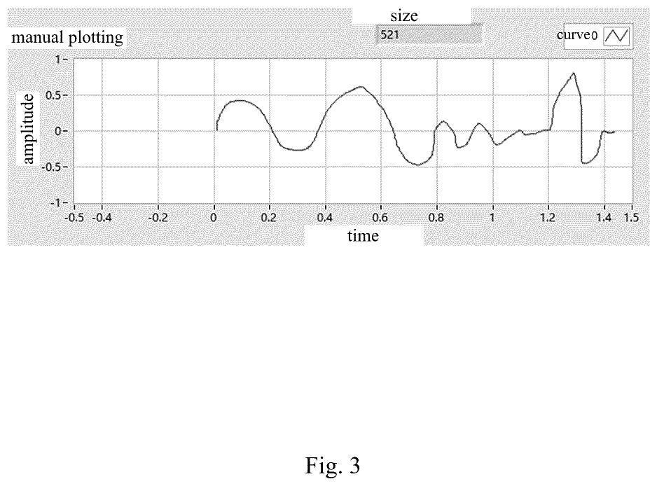

Specifically, in this implementation, the waveform may be pre-plotted in an electronical manual plotting manner, which not only offers flexibility in designing a waveform curve based on a user's demand on tactile experience (e.g., enabling flexible adjustment of waveform signal parameters such as frequency, amplitude, and intensity), but also may intuitively display characteristics of the signal to facilitate real-time modification of the waveform curve, whereby efficiency of drive signal generation is enhanced and vibration tactile experience is improved. As illustrated in FIG. 2, in some examples, first coordinate parameters of respective key data points in the waveform signal may be first determined, and then the first coordinate parameters of the respective key data points are inputted in a preset software plotting model, so that the initial waveform curve is generated and displayed via the software plotting model and meanwhile the first waveform signal corresponding to the initial waveform curve is generated. Of course, as illustrated in FIG. 3, in some other examples, a waveform trend of the first waveform signal may also be first determined based on the vibration waveform information, and then an entire piece of continuous initial waveform curve can be plotted in conjunction with restrictive parameters such as amplitudes or frequencies.

In some other examples of this implementation, the vibration waveform information includes a waveform graph corresponding to the vibration waveform satisfying the requirement of ideal tactile experience; correspondingly, the step of plotting an initial waveform curve based on vibration waveform information of a motor and generating a first waveform signal corresponding to the initial waveform curve comprises: extracting waveform characteristics in the waveform graph using a preset image recognition algorithm; plotting the initial waveform curve based on the waveform characteristics, and generating the first waveform signal corresponding to the initial waveform curve.

Specifically, the waveform graph may be an externally imported waveform graph or may be pre-designed according to a user's requirement on tactile experience of the motor, which bears noticeable curve information. In some examples, the image recognition and characteristics extraction may be performed using an algorithm model such as edge detection, envelop plotting, and contour extraction to obtain valid waveform characteristics, and then the initial waveform curve is plotted and the desired first waveform signal is generated.

Step 102: resample the first waveform signal based on a preset sampling rate and a duration of the first waveform signal to obtain a second waveform signal.

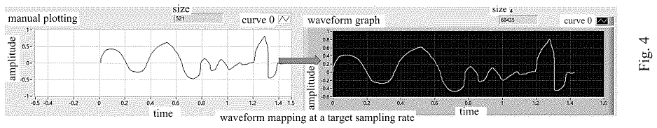

Specifically, during the resampling process, data points in the signal may be added or reduced appropriately by adjusting the sampling rate, as illustrated in FIG. 4, so that the first waveform signal (SignalA) is mapped to a second waveform signal (SignalB) which has more complete information.

Furthermore, in some examples of this implementation, the step of resampling the first waveform signal based on a preset sampling rate and a duration of the first waveform signal to obtain a second waveform signal comprises: determining, based on the preset sampling rate and the duration of the first waveform signal, second coordinate parameters of respective sample points of the first waveform signal in the first planar coordinate system; and mapping, based on the respective second coordinate parameters, the initial waveform curve of the first waveform signal to the second planar coordinate system to obtain a reference waveform curve, and generating a second waveform signal corresponding to the reference waveform curve.

Specifically, at first, a start time point of the first waveform signal may be aligned with the zero point of a time axis; next, a count of sample points of the first waveform signal and sampling time corresponding to respective sample points are calculated based on the preset sampling rate and the duration of the first waveform signal; second coordinate parameters of the respective sample points in the first planar coordinate system are determined based on the sampling times corresponding to the respective sample points; then, the initial waveform curve of the first waveform signal may be mapped to the second planar coordinate system to obtain a reference waveform curve, and a second waveform signal corresponding to the reference waveform curve is generated.

Furthermore, in some examples of this implementation, the step of mapping, based on the respective second coordinate parameters, the initial waveform curve of the first waveform signal to the second planar coordinate system to obtain a reference waveform curve, and generating a second waveform signal corresponding to the reference waveform curve comprises: locating, on the initial waveform curve of the first waveform signal, all neighboring sample points of a data point corresponding to a target time point; calculating, based on the second coordinate parameters of all neighboring sample points corresponding to respective target time points, third coordinate parameters of respective target data points in the second planar coordinate system; and plotting the reference waveform curve based on the third coordinate parameters of the target data points corresponding to the respective target time points, and generating the second waveform signal corresponding to the reference waveform curve.

Specifically, coordinate information of respective data points in the reference waveform curve may be inferred based on a preset linear relational expression. For example, for third coordinate parameters (XB1, YB1) of a target data point B1 in the second planar coordinate system, time axis coordinate parameter XB1 of the target data point B1 is given; based on the time axis coordinate parameter XB1, neighboring sample points A1 and A2 of the data point whose time axis coordinate parameter on the initial waveform curve is XB1 are located, the A1 and A2 being determines as the target sample points for calculating amplitude coordinate parameter YB1; then, YB1 may be calculated according to the linear relational expression below based on the corresponding second coordinate parameters A1 (XA1, YA1) and A2 (XA2, YA2):

$$YB 1 = \frac{X B 1 - X A 1}{X A 2 - X A 1} * ( YA 2 - YA 1 ) + Y A 1 .$$

In some other examples of this implementation, the step of mapping, based on the respective second coordinate parameters, the initial waveform curve of the first waveform signal to the second planar coordinate system to obtain a reference waveform curve, and generating a second waveform signal corresponding to the reference waveform curve comprises: performing linear fitting to the first waveform signal based on the respective second coordinate parameters to obtain an expression of the second waveform signal; calculating third coordinate parameters of respective data points in the reference waveform curve of the second waveform signal based on the expression of the second waveform signal; and plotting the reference waveform curve based on the respective third coordinate parameters and generating the corresponding second waveform signal.

Specifically, each point may be inferred based on curve trend to complete all data points. The linear fitting may be performed using an appropriate advanced fitting algorithm, for example, for given sample points A1, A2 . . . An, the first waveform signal is fitted with an appropriate advanced fitting algorithm to obtain an expression FunctionA, and then the time-axis coordinate parameter of each data point of the second waveform signal is substituted into the expression FunctionA, respectively, whereby the corresponding amplitude parameter can be calculated. Optionally, the linear fitting in this implementation may refer to polynomial fitting, curve fitting, spline fitting, and etc., which is not limited herein. In a specific implementation process, the fitting may be performed in a global fitting or segmental fitting manner.

Step 103: perform filtering processing and displacement protection processing to the second waveform signal to obtain the motor drive signal.

Specifically, the motor drive signal serves to drive the motor to vibrate within a target operating frequency band. By thinning and optimizing processing to the waveform signal via operations such as filtering processing and displacement protection processing, a desired motor drive signal is generated, which ensures that the motor would not hit the vibrator casing during the actual driving process.

In some examples of the implementation, the step of performing filtering processing and displacement protection processing to the second waveform signal to obtain the motor drive signal comprises: performing filtering processing to the second waveform signal based on a preset cut-off frequency to obtain a third waveform signal (SignalC), where the cut-off frequency is determined based on a target operating frequency band; and performing displacement protection processing to the third waveform signal to obtain a motor drive signal (SignalD).

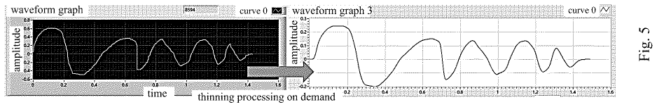

Specifically, the filtering may be low-pass, high-pass, band-pass, or band-elimination, etc., which may be flexibly determined based on the waveform characteristics of the second waveform signal. In some examples of this implementation, low-pass filtering may be selected to reduce the high-frequency component of the signal voltage, which prevents abnormal sound caused by high-frequency voltage; and high-pass filtering may be selected to reduce low-frequency energy loss so that the motor operates within the target operating frequency band. FIG. 5 illustrates filtering processing to the second waveform signal based on a preset cut-off frequency. In a specific example, the target operating frequency band of motor may be set to 50-500 Hz, within which range the motor may realize desired tactile feedback; and the cut-off frequency may be determined based on this frequency-band range. In addition, in some other examples, the waveform signal may be manually modified, i.e., when performing data processing, the unsmooth data points may be manually processed, and then a series of fine tuning such as sampling rate adjustment and data scaling may be performed.

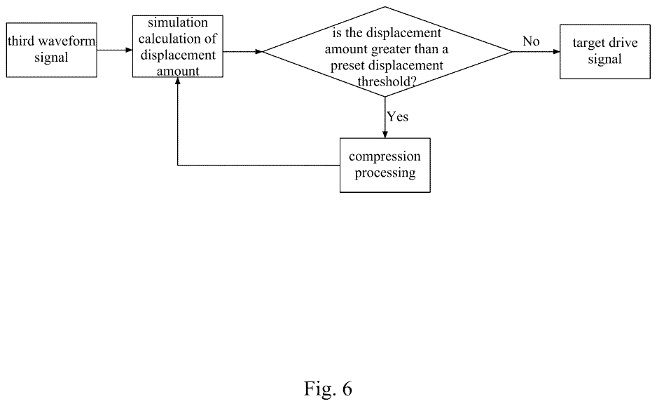

Furthermore, as illustrated in FIG. 6, in some examples of this implementation, the step of performing displacement protection processing to the third waveform signal to obtain a motor drive signal comprises: performing simulation calculation to the third waveform signal to obtain a displacement amount of the third waveform signal; performing, in a case that the displacement amount is greater than a preset displacement threshold, compression processing to the third waveform signal based on a difference between the displacement amount and the displacement threshold to obtain a motor drive signal.

Specifically, a displacement protection module may be leveraged to perform displacement protection processing to the third waveform signal, i.e., the simulation calculation to the third waveform signal is performed by the displacement protection module to obtain a displacement amount of the third waveform signal; the displacement amount is compared with the preset displacement threshold, where in a case that the displacement amount is less than or equal to the preset displacement threshold, the voltage may not be processed; and in a case that the displacement amount is greater than the preset displacement threshold, the compression processing may be performed to the third waveform signal so that a displacement simulation result of the compressed signal does not exceed the displacement threshold, ensuring that the motor does not hit the vibrator casing during the actual driving process.

Furthermore, in some examples of the disclosure, the step of performing, in a case that the displacement amount is greater than a preset displacement threshold, compression processing to the third waveform signal based on a difference between the displacement amount and the displacement threshold to obtain a motor drive signal comprises: determining, in a case that the displacement amount is greater than the preset displacement threshold, a corresponding compression factor based on the difference between the displacement amount and the displacement threshold; and performing compression processing to amplitudes of respective data points in the third waveform signal based on the compression factor to obtain the motor drive signal.

Specifically, the compression processing may be performed based on a ratio of the displacement amount over the displacement threshold; given that the displacement threshold is Xmax1 and the maximum displacement amount resulting from the simulation calculation is Xmax2, the compression factor is set as S=Xmax1/Xmax2, and by scaling the amplitudes of all data points of the third waveform signal based on the compression factor S, the motor drive signal may be obtained.

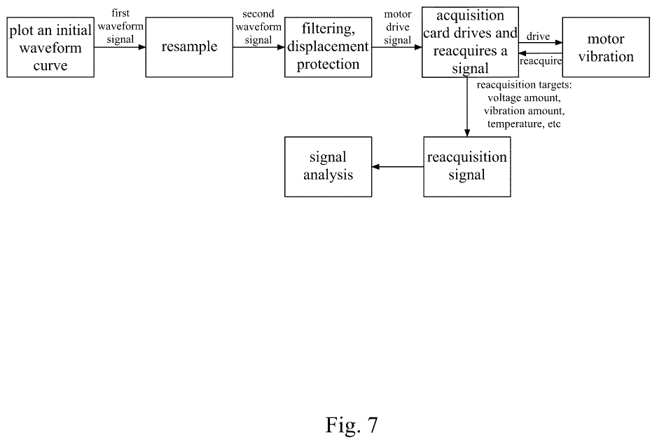

In some examples of this implementation, the obtained motor drive signal may be transmitted to a corresponding control to realize functions including hardware driving and data simulation. As illustrated in FIG. 7, an acquisition card comprises an input channel, a sampling module, and a signal conditioning circuit, etc., which may acquire the motor drive signal and the reacquired signal in real time and perform corresponding processing. In this example, the motor drive signal may be acquired by the acquisition card, and the motor is driven to vibrate based on the motor drive signal; after the motor is activated, signal reacquisition may also be performed to analyze the reacquired signal (e.g., determining parameters of the motor such as actual vibration amount, voltage amount, and temperature), thereby realizing real-time monitoring and adjustment of the operating conditions of the motor.

Compared with the conventional technologies, the method of generating a motor drive signal according to this implementation comprises: plotting an initial waveform curve based on vibration waveform information of a motor and generating a first waveform signal corresponding to the initial waveform curve, where the vibration waveform information is vibration information allowing for a vibration action of the motor to satisfy a requirement of desired tactility, and the waveform curve characterizes change of signal amplitude over time; resampling the first waveform signal based on a preset sampling rate and a duration of the first waveform signal to obtain a second waveform signal; and performing filtering processing and displacement protection processing to the second waveform signal to obtain the motor drive signal, where the motor drive signal is configured to drive the motor to vibrate within a target operating frequency band. Through implementation of the present solution, a desired motor drive signal can be generated by plotting a waveform dependent on different tactile requirements of users or application scenarios, and optimizing the waveform signal by resampling, filtering processing, and displacement protection processing, which minimizes a difference between the actual vibration tactility of the motor and the ideal vibration tactility, whereby tactile experience of users is enhanced.

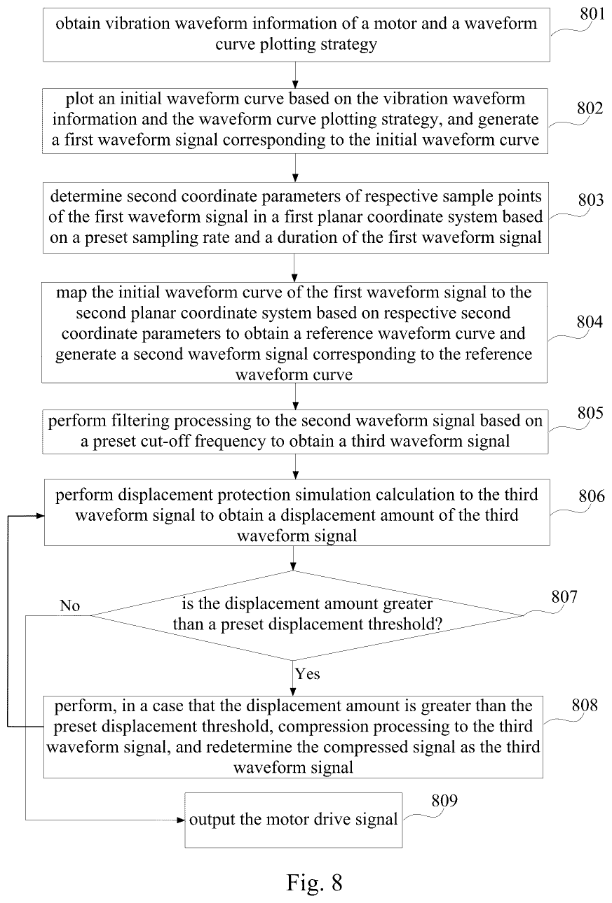

FIG. 8 illustrates a refined method of generating a motor drive signal according to a second implementation of the disclosure, comprising:
Step 801: obtain vibration waveform information of a motor and a waveform curve plotting strategy;
Step 802: plot an initial waveform curve based on the vibration waveform information and the waveform curve plotting strategy, and generate a first waveform signal corresponding to the initial waveform curve;
Step 803: determine second coordinate parameters of respective sample points of the first waveform signal in a first planar coordinate system based on a preset sampling rate and a duration of the first waveform signal;
Step 804: map the initial waveform curve of the first waveform signal to the second planar coordinate system based on respective second coordinate parameters to obtain a reference waveform curve, and generate a second waveform signal corresponding to the reference waveform curve;
Step 805: perform filtering processing to the second waveform signal based on a preset cut-off frequency to obtain a third waveform signal;
Step 806: perform displacement protection simulation calculation to the third waveform signal to obtain a displacement amount of the third waveform signal;
Step 807: compare the displacement amount with a preset displacement threshold to determine whether the displacement amount is greater than the preset displacement threshold;
Step 808: perform, in a case that the displacement amount is greater than the preset displacement threshold, compression processing to the third waveform signal based on a difference between the displacement amount and the displacement threshold, and redetermine the compressed signal as the third waveform signal, followed by returning to step 806; and
Step 809: output the motor drive signal in a case that the displacement amount is less than or equal to the preset displacement threshold.

It would be understood that, in this implementation, serial numbers of respective steps do not indicate absolute sequences in executing the steps; the execution sequences of the steps shall be determined based on their functions and internal logic, which shall not constitute an exclusive limitation to the implementation procedures of the present disclosure.

Compared with the conventional technologies, this implementation of the disclosure enables selection of an appropriate plotting strategy to plot a waveform curve so as to design a vibration tactility control solution satisfying user requirements; in addition, after the waveform curve is roughly plotted, the signal waveform characteristics can be optimized flexibly and efficiently, whereby a desired drive signal is generated.

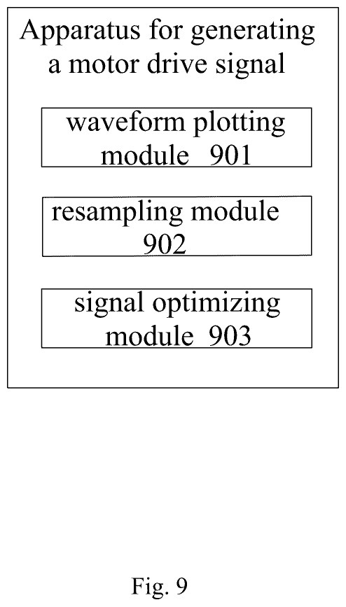

FIG. 9 illustrates an apparatus for generating a motor drive signal according to a third implementation of the disclosure, which may be applied to the methods of generating a motor drive signal described supra. As illustrated in FIG. 9, the apparatus for generating a motor drive signal mainly comprises:
a waveform plotting module 901 configured to plot an initial waveform curve based on vibration waveform information of a motor and generate a first waveform signal corresponding to the initial waveform curve, where the vibration waveform information is vibration information allowing for a vibration action of the motor to satisfy a requirement of desired tactility, and the waveform curve characterizes change of signal amplitude over time;
a resampling module 902 configured to resample the first waveform signal based on a preset sampling rate and a duration of the first waveform signal to obtain a second waveform signal; and
a signal optimizing module 903 configured to perform filtering processing and displacement protection processing to the second waveform signal to obtain the motor drive signal, where the motor drive signal is configured to drive the motor to vibrate within a target operating frequency band.

In some examples of this implementation, the waveform plotting module is configured to determine, based on the vibration waveform information of the motor, first coordinate parameters of respective key data points of the first waveform signal in a first planar coordinate system; and plot the initial waveform curve based on the respective first coordinate parameters and generate the first waveform signal corresponding to the initial waveform curve.

In some other examples of this implementation, the vibration waveform information includes a waveform graph corresponding to the vibration waveform satisfying the requirement of ideal tactile experience; correspondingly, the waveform plotting module is configured to: extract waveform characteristics in the waveform graph using a preset image recognition algorithm; plot the initial waveform curve based on the waveform characteristics, and generate the first waveform signal corresponding to the initial waveform curve.

In some examples of this implementation, the resampling module is configured to: determine, based on the preset sampling rate and the duration of the first waveform signal, second coordinate parameters of respective sample points of the first waveform signal in the first planar coordinate system; and map, based on respective second coordinate parameters, the initial waveform curve of the first waveform signal to the second planar coordinate system to obtain a reference waveform curve, and generate a second waveform signal corresponding to the reference waveform curve.

Furthermore, in some examples of this implementation, when performing the function of mapping, based on the respective second coordinate parameters, the initial waveform curve of the first waveform signal to the second planar coordinate system to obtain a reference waveform curve, and generating a second waveform signal corresponding to the reference waveform curve, the resampling module is specifically configured to: locate, on the initial waveform curve of the first waveform signal, all neighboring sample points of a data point corresponding to a target time point; calculate, based on the second coordinate parameters of all neighboring sample points corresponding to respective target time points, third coordinate parameters of respective target data points in the second planar coordinate system; and plot the reference waveform curve based on third coordinate parameters of the target data points corresponding to the respective target time points, and generate the second waveform signal corresponding to the reference waveform curve.

In some examples of this implementation, when performing the function of mapping, based on the respective second coordinate parameters, the initial waveform curve of the first waveform signal to the second planar coordinate system to obtain a reference waveform curve, and generating a second waveform signal corresponding to the reference waveform curve, the resampling module is specifically configured to: perform linear fitting to the first waveform signal based on the respective second coordinate parameters to obtain an expression of the second waveform signal; calculate third coordinate parameters of respective data points in the reference waveform curve of the second waveform signal based on the expression of the second waveform signal; and plot the reference waveform curve based on respective third coordinate parameters and generate the corresponding second waveform signal.

In some examples of this implementation, the signal optimizing module is configured to: perform filtering processing to the second waveform signal based on a preset cut-off frequency to obtain a third waveform signal, and perform displacement protection processing to the third waveform signal to obtain a motor drive signal.

Furthermore, in some examples of this implementation, when performing the function of performing displacement protection processing to the third waveform signal to obtain a motor drive signal, the signal optimizing module is specifically configured to: perform simulation calculation to the third waveform signal to obtain a displacement amount of the third waveform signal; and perform, in a case that the displacement amount is greater than a preset displacement threshold, compression processing to the third waveform signal based on a difference between the displacement amount and the displacement threshold to obtain a motor drive signal.

Furthermore, in some examples of this implementation, when performing the function of performing, in a case that the displacement amount is greater than a preset displacement threshold, compression processing to the third waveform signal based on a difference between the displacement amount and the displacement threshold to obtain a motor drive signal, the signal optimizing module is specifically configured to: determine, in a case that the displacement amount is greater than the preset displacement threshold, a corresponding compression factor based on the difference between the displacement amount and the displacement threshold; and perform compression processing to amplitudes of respective data points in the third waveform signal based on the compression factor to obtain the motor drive signal.

The apparatus for generating a motor drive signal according to this implementation is applied to: plot an initial waveform curve based on vibration waveform information of a motor and generate a first waveform signal corresponding to the initial waveform curve, where the vibration waveform information is vibration information allowing for a vibration action of the motor to satisfy a requirement of desired tactility, and the waveform curve characterizes change of signal amplitude over time; resample the first waveform signal based on a preset sampling rate and a duration of the first waveform signal to obtain a second waveform signal; and perform filtering processing and displacement protection processing to the second waveform signal to obtain the motor drive signal, where the motor drive signal is configured to drive the motor to vibrate within a target operating frequency band. Through implementation of the present solution, a desired motor drive signal can be generated by plotting a waveform dependent on different tactile requirements of users or application scenarios, and optimizing the waveform signal by resampling, filtering processing, and displacement protection processing, which minimizes a difference between the actual vibration tactility of the motor and the ideal vibration tactility, whereby tactile experience of users is enhanced.

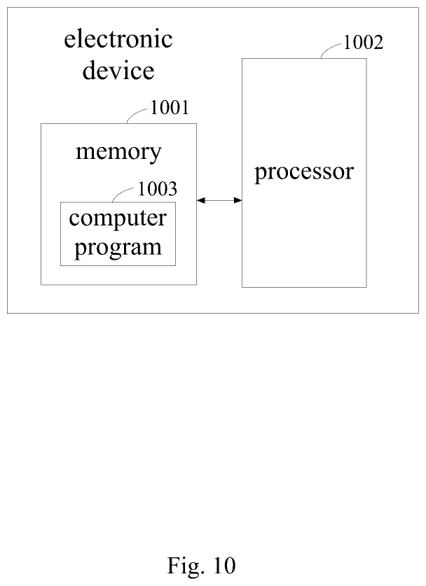

FIG. 10 illustrates an electronic device according to a fourth implementation of the disclosure. The electronic device may be applied to implement the methods for generating a motor drive signal as described in the preceding implementations. The electronic device mainly comprises: a memory 1001, a processor 1102, and a computer program 1003 stored on the memory 1001 and executable on the processor 1002; the memory 1001 communicates with the processor 1002. The processor 1002, when executing the computer program 1003, implements the methods described in the preceding implementations. In this implementation, one or more processors may be provided.

The memory 1001 may be a high-speed RAM (Random Access Memory) or a non-volatile memory, e.g., a magnetic disk memory. The memory 1001 is configured to store executable codes, the processor 1002 being coupled to the memory 1001.

Furthermore, implementations of the present disclosure further provide a computer-readable storage medium, which may be set in the electronic device; the computer-readable storage medium may be the memory in the implementation illustrated in FIG. 10.

The computer-readable storage medium has a computer program stored thereon, the program, when being executed by the processor, carries out the methods for generating a motor drive signal in the implementation described supra. Furthermore, the computer-readable storage medium may also be various mediums that may store the computer program such as a U disk, an external hard disk, a ROM (Read-Only Memory), a RAM, a magnetic disk, or an optical disk.

In the several implementations described herein, it should be understood that the apparatus and the method as disclosed may also be otherwise implemented. For example, the apparatus implementation described supra is only schematic; for example, partition of modules is only a logic function partition, which may be altered in actual implementations; for example, a plurality of modules or components may be combined or may be integrated to another system; or some features may be omitted or not executed. Furthermore, the mutual coupling therebetween, or the direct coupling, or the communicative connection as disclosed or discussed may be implemented via some interfaces; the indirect coupling or communicative connection between devices or modules may be electrical, or mechanical, or the like.

The modules described as discrete parts may be physically separated or not physically separated; the parts illustrated as modules may be physical modules or not physical modules, i.e., they may be located at a same place or may be distributed on a plurality of network modules. Part or all of the modules may be selected to carry out the solution of this implementation dependent on actual needs.

Additionally, various functional modules in various implementations of the disclosure may be integrated on one processing module or may be standalone physical modules; or two or more modules are integrated on one module. The integrated module may be implemented in a hardware manner or in a form of software functional modules.

If the integrated module is implemented in a software functional module and sold or used as an independent product, it may be stored in a computer-readable storage medium. Based on this understanding, the essential technical solution of the present disclosure, or the part of the disclosure contributing to conventional technologies, or all or part of the technical solution may be embodied in a form of a software product; the computer software product is stored in a readable storage medium, comprising several instructions enabling a computer device (which may be a personal computer, a server, or a network device or the like) to carry out all or part of the steps of the method in respective implementations. The readable storage medium includes various mediums that may store program codes such as a U disk, an external hard disk, a ROM (Read-Only Memory), a RAM, a magnetic disk, or an optical disk.

It is noted that, for ease of description, the method implementation described supra is expressed as a combination of a series of actions; however, those skilled in the art shall know that, the present disclosure is not limited by the sequence of actions as described, because some steps may be performed in another sequence or performed simultaneously according to the disclosure. Secondly, those skilled in the art shall also know that, the implementations described herein are all exemplary, and not all actions and modules involved are essential to the disclosure.

The implementations noted supra focus on different aspects of the disclosure; for those parts not detailed in one implementation, they may refer to relevant descriptions in other implementations.

What have been described supra relate to the methods for generating a motor drive signal, apparatus, device, and a readable storage medium provided by the present disclosure; to those skilled in the art, the specific implementations and application scopes may be altered according to the invention concept of the disclosure; therefore, the contents of the description shall not be construed as limitation to the disclosure.

I/We claim:

1. A method of generating a motor drive signal, comprising:
plotting an initial waveform curve based on vibration waveform information of a motor and generating a first waveform signal corresponding to the initial waveform curve, wherein the vibration waveform information is vibration information allowing for a vibration action of the motor to satisfy a requirement of desired tactility, and the waveform curve characterizes change of signal amplitude over time;
resampling the first waveform signal based on a preset sampling rate and a duration of the first waveform signal to obtain a second waveform signal; and
performing filtering processing and displacement protection processing to the second waveform signal to obtain a motor drive signal, wherein the motor drive signal is configured to drive the motor to vibrate within a target operating frequency band.

2. The method of generating a motor drive signal according to claim 1, wherein the plotting an initial waveform curve based on vibration waveform information of a motor and generating a first waveform signal corresponding to the initial waveform curve comprises:
determining, based on the vibration waveform information of the motor, first coordinate parameters of respective key data points of the first waveform signal in a first planar coordinate system; and
plotting the initial waveform curve based on the respective first coordinate parameters and generating the first waveform signal corresponding to the initial waveform curve.

3. The method of generating a motor drive signal according to claim 1, wherein the vibration waveform information includes a waveform graph corresponding to the vibration waveform satisfying the requirement of ideal tactile experience;
the step of plotting an initial waveform curve based on vibration waveform information of a motor and generating a first waveform signal corresponding to the initial waveform curve comprises:
extracting waveform characteristics in the waveform graph using a preset image recognition algorithm; and
plotting the initial waveform curve based on the waveform characteristics, and generating the first waveform signal corresponding to the initial waveform curve.

4. The method of generating a motor drive signal according to claim 1, wherein the resampling the first waveform signal based on a preset sampling rate and a duration of the first waveform signal to obtain a second waveform signal comprises:
determining, based on the preset sampling rate and the duration of the first waveform signal, second coordinate parameters of respective sample points of the first waveform signal in the first planar coordinate system; and
mapping, based on the respective second coordinate parameters, the initial waveform curve of the first waveform signal to the second planar coordinate system to obtain a reference waveform curve, and generating a second waveform signal corresponding to the reference waveform curve.

5. The method of generating a motor drive signal according to claim 4, wherein the mapping, based on the respective second coordinate parameters, the initial waveform curve of the first waveform signal to the second planar coordinate system to obtain a reference waveform curve, and generating a second waveform signal corresponding to the reference waveform curve comprises:
locating, on the initial waveform curve of the first waveform signal, all neighboring sample points of a data point corresponding to a target time point;
calculating, based on the second coordinate parameters of all neighboring sample points corresponding to respective target time points, third coordinate parameters of respective target data points in the second planar coordinate system; and
plotting the reference waveform curve based on the third coordinate parameters of the target data points corresponding to the respective target time points, and generating the second waveform signal corresponding to the reference waveform curve.

6. The method of generating a motor drive signal according to claim 4, wherein the mapping, based on the respective second coordinate parameters, the initial waveform curve of the first waveform signal to the second planar coordinate system to obtain a reference waveform curve, and generating a second waveform signal corresponding to the reference waveform curve comprises:
performing linear fitting to the first waveform signal based on the respective second coordinate parameters to obtain an expression of the second waveform signal;
calculating third coordinate parameters of respective data points in the reference waveform curve of the second waveform signal based on the expression of the second waveform signal; and
plotting the reference waveform curve based on the respective third coordinate parameters and generating the corresponding second waveform signal.

7. The method of generating a motor drive signal according to claim 1, wherein the performing filtering processing and displacement protection processing to the second waveform signal to obtain a motor drive signal comprises:
performing filtering processing to the second waveform signal based on a preset cut-off frequency to obtain a third waveform signal, wherein the cut-off frequency is determined based on a target operating frequency band; and
performing displacement protection processing to the third waveform signal to obtain a motor drive signal.

8. The method of generating a motor drive signal according to claim 7, wherein the performing displacement protection processing to the third waveform signal to obtain a motor drive signal comprises:
performing simulation calculation to the third waveform signal to obtain a displacement amount of the third waveform signal; and
performing, in a case that the displacement amount is greater than a preset displacement threshold, compression processing to the third waveform signal based on a difference between the displacement amount and the displacement threshold to obtain a motor drive signal.

9. The method of generating a motor drive signal according to claim 8, wherein the performing, in a case that the displacement amount is greater than a preset displacement threshold, compression processing to the third waveform signal based on a difference between the displacement amount and the displacement threshold to obtain a motor drive signal comprises:
determining, in a case that the displacement amount is greater than the preset displacement threshold, a corresponding compression factor based on the difference between the displacement amount and the displacement threshold; and
performing compression processing to amplitudes of respective data points in the third waveform signal based on the compression factor to obtain the motor drive signal.

10. The apparatus for generating a motor drive signal, comprising:
a waveform plotting module configured to plot an initial waveform curve based on vibration waveform information of a motor and generate a first waveform signal corresponding to the initial waveform curve, wherein the vibration waveform information is vibration information allowing for a vibration action of the motor to satisfy a requirement of desired tactility, and the waveform curve characterizes change of signal amplitude over time;
a resampling module configured to resample the first waveform signal based on a preset sampling rate and a duration of the first waveform signal to obtain a second waveform signal; and
a signal optimizing module configured to perform filtering processing and displacement protection processing to the second waveform signal to obtain the motor drive signal, wherein the motor drive signal is configured to drive the motor to vibrate within a target operating frequency band.

11. An electronic device, comprising a memory and a processor, wherein:
the processor is configured to execute a computer program stored on the memory; and
the processor, when executing the computer program, performs steps in the method according to claim 1.
